(19) United States
(12) Patent Application Publication
(10) Pub. No.: US 2010/0284465 A1
(43) Pub. Date: Nov. 11, 2010

(54) METHOD FOR COMPRESSING DATA IN A VIDEO SEQUENCE

(76) Inventors: Ulrich-Lorenz Benzler, Langenhagen (DE); Steffen Kamp, Aachen (DE)

Correspondence Address: KENYON & KENYON LLP, ONE BROADWAY, NEW YORK, NY, 10004, US

(21) Appl. No.: 12/308,301

(22) PCT Filed: Sep. 4, 2007
(86) PCT No.: PCT/EP2007/059209

§ 371 Date: Jul. 28, 2010

(30) Foreign Application Priority Data
Sep. 18, 2006 (DE) 102006043707.1

(51) Int. Cl. H04N 7/26

(52) U.S. Cl. 375/240.16; 375/E07.123

(57) ABSTRACT

A method for compressing data in a video sequence, a system for carrying out the method, a computer program, and a computer program product are provided. In the described method, results of a motion estimation for a previous temporal decomposition stage are also used for motion compensation.

### FIELD OF THE INVENTION

The present invention relates to a method for compressing data in a video sequence, a system for carrying out the method, a computer program and a computer program product.

### BACKGROUND INFORMATION

In the transmission and processing of video data, so-called data compression methods are used, for example, to reduce the data volume by combining redundant data to allow faster transmission of the data.

In current video coding procedures, motion compensation represents a key factor in compression efficiency. However, it must be taken into account that a motion estimation, i.e., the determination of the motion parameters of a video sequence, carried out during motion compensation requires extensive computation and takes the most time during coding.

Many video coding standards, such as MPEG-1/2/4 and H.264/AVC, for example, use so-called block-based motion compensation in which individual images are divided into rectangularly partitioned pixel regions, and a shifted block from a reference image is used as a prediction for each partition. The coder codes only the shift, namely, a travel or motion vector, for each region, and a structural deviation which represents the difference between the region actually coded and the prediction.

For scalable video coding (SVC), which is based on a motion-compensated time filter or hierarchical, bidirectionally predicted images (B-slices), a correlation of motion parameters in various temporal and spatial decomposition stages may be expected.

Algorithms for rapid motion estimation may considerably reduce the number of computation steps, although the compression efficiency is only minimally decreased. In comparison to a moving image vector search, such algorithms reduce the set of motion vectors to be tested in order to conserve search patterns. In this manner a search pattern centered around the best vector candidates may be used.

For typical video sequences, moving objects often overlap image regions which are larger than the maximum block size for the motion compensation or the macroblock size. For this reason, spatially adjacent motion vectors often show a large dependency, this fact being frequently employed in video coding systems by coding only the difference between a current motion vector and an associated motion vector predictor (MVP), which in turn is derived from causal, spatially adjacent vectors.

In addition, a correlation between temporally adjacent vectors may likewise be estimated on the basis of content within individual scenes which changes only very slowly. Many methods for motion estimation use a motion vector predictor as the initial vector, around which the search algorithm is centered. Another procedure provides that only one set of candidates is used which is composed of motion vector predictors and vectors derived therefrom.

### SUMMARY OF THE INVENTION

The present invention relates to a method for compressing data in a video sequence, in which results of a motion estimation for a previous temporal decomposition stage are also used for the motion compensation. The results are used to predict vector candidates for the next decomposition stage, since the computational complexity of algorithms for motion estimation is very great, in particular when the time interval between images is very large, which is the case, for example, for scalable video coding. It is therefore provided that a predictive motion estimation algorithm is used which employs a motion correlation which is present in particular for scalable video coding, based on motion-compensated time filters or the use of so-called open hierarchical, bidirectionally predicted images.

The provided algorithm greatly reduces the computational scope for the motion estimation stage. The objective and visual quality essentially corresponds to that of known extensive, complete search algorithms.

In the embodiment the algorithm includes a candidate set of (exact) full-pixel motion vectors for forward and backward directed prediction of each (sub)partition of a macroblock. Computation of the motion vector candidates requires access to vectors of either the current image or of previously estimated image vector fields. The individual candidates of full-pixel candidate set S are selected as follows:

### Zero Vector Candidates

Many scenes contain little or no camera or background motion. Therefore a backward directed zero vector (0, 0) is added to the candidate set.

### Spatial Vector Candidates

Up to three candidates per prediction direction are derived from spatially adjacent partitions or sections within the current image. Next the motion vector predictor is considered, which is likewise used for differential coding of the current motion vector and is derived in a known manner, as described, for example, in the publication “Joint final draft international standard (FDIS) of joint video specification (ITU-T rec. H.264/ISO/IEC 14496-10 AVC)” in JVT, 7th Meeting, Document JVT-G050, Pattaya, Thailand, March 2003, ITU-T, ISO/IEC by Thomas Wiegand and Garry Sullivan.

The motion vectors for the partitions of the left neighbor and of the neighbor to the upper right, which are obtained from the motion vectors used for computing the motion vector predictor, are likewise included if they are available. If the neighbor to the upper right is not present, the neighbor to the upper left is used instead.

### Temporal Vector Candidates

The temporal vector candidates for a forward directed and a backward directed estimation are derived in various ways, based on the availability of previously determined motion vectors. Backward directed motion vector candidates are derived from inverted forward directed motion vectors of the current image. Therefore, on account of causality limitations only motion vectors from above or to the left of the current macroblock are used. Two previously stored motion vectors of the macroblocks to the upper left and right, relative to the current macroblock, are selected as temporal vector candidates. For forward directed motion vectors the situation is different, since each of the forward directed motion vectors from the already estimated motion vector field of the previous image may be used as a candidate. The selected forward directed candidates are the inverted motion vectors of the stored motion field, and are obtained from the neighbors to the left and right below the colocated macroblock.

### Temporal Interlayer Vector Candidates

The temporal interlayer vector candidates (ILC) are provided for improving a vector prediction. This is the case in particular in conjunction with a motion-compensated temporal filter or for open hierarchical, bidirectionally predicted images. The time interval between motion-compensated images doubles for each temporal decomposition stage. This would actually require an increased motion vector search region for the motion estimation. However, it is possible to combine motion vectors from previous stages in order to predict the motion in subsequent stages. A candidate for temporal layer 1 is computed from previous temporal decomposition stage 1-1 on the basis of a pair composed of one forward directed and one backward directed motion vector.

Since all candidates except for the candidate for the motion vector predictor are derived directly from previous image estimation results, a method for adapting to the changing motion in the sequence is advantageous. Therefore a vector set S is provided by adding each vector from set S to a randomly selected vector rᵢ, resulting in a final vector set S_{final}

S_{final}={v₁, . . . vₙ,v₁r₁, . . . vₙ+rₙ}.

In the embodiment, the best candidate for the motion vector is determined by minimizing a cost function for all unique vectors of the final vector set. A subsequent full-pixel refinement of a pattern search for the best motion vector candidates may likewise be carried out.

It may be provided that, by first evaluating the eight surrounding half-pixel positions and then testing the eight quarter-pixel positions for the best half-pixel candidates, ultimately a subpixel refinement is carried out.

For selection of the coding mode, the costs of the data rate-to-image distortion ratio from the two unidirectional modes and the bidirectional mode may be compared, the two best unidirectional motion vectors being used without further bidirectional refinement.

A system which is designed for carrying out the previously described method is also provided. This system generally includes a computing unit.

The present invention further relates to a computer program having program code for carrying out all the steps of a method according to the present invention when the computer program is executed on a computer or a corresponding computing unit.

The present invention further relates to a computer program product having program code which are stored on a computer-readable data carrier for carrying out all the steps of a method according to the present invention when the computer program is executed on a computer or a corresponding computing unit.

Further advantages and embodiments of the present invention result from the description and the accompanying drawing.

It is understood that the features mentioned above and to be described below may be used not only in the particular stated combination, but also in other combinations or alone, without departing from the scope of the present invention.

The present invention is schematically illustrated in the drawing on the basis of exemplary embodiments, and is described in detail below with reference to the drawing.

### BRIEF DESCRIPTION OF THE DRAWINGS

FIG. 1 shows two different candidate association diagrams for illustrating the method according to the present invention.

FIG. 2 shows the generation of a motion vector set on the basis of various information sources for a motion estimation.

FIG. 3 shows a schematic illustration of one embodiment of the system according to the present invention.

### DETAILED DESCRIPTION

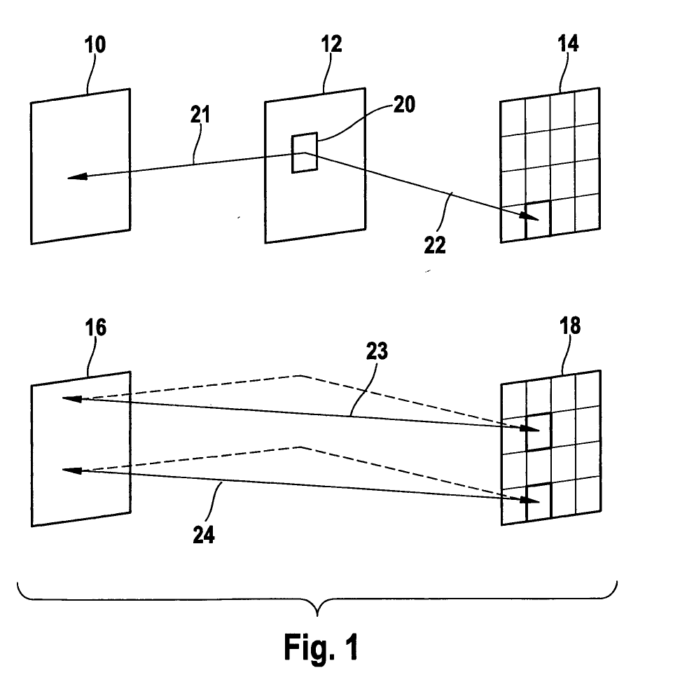

FIG. 1 illustrates various association diagrams for candidates for the temporal interlayer. A first frame 10 for vector set s¹⁻¹₂ₜ₋₂, a second frame 12 for vector set s¹⁻¹₂ₜ₋₁, and a third frame 14 for vector set s¹⁻¹₂ₜ are illustrated in the upper region. A fourth frame 16 for vector set s¹ₜ₋₁ and a fifth frame 18 for vector set s¹ₜ are illustrated in the lower region of the figure.

According to the upper part of the figure, a candidate for a vector for a block 20 is determined from frame 10 using vector 21 v_{fwd}, and is determined from frame 14 using vector 22 V_{bwd}. A candidate for temporal layer 1 is thus determined on the basis of a stored pair of a forward directed motion vector and a backward directed motion vector from previous temporal decomposition stage 1-1.

As shown in the lower part of the illustration, in principle two candidate association diagrams may be used. This may be achieved by associating the candidates with the particular colocated block using vector 23 v_{fwd}, and by associating the candidates with the block which follows the motion trajectory, using vector 24 v_{fwd,trj}. The block in s¹⁻¹₂ₜ has maximum overlap with the referenced region of determined V_{bwd}, and its colocated block in s¹ₜ is associated with v_{fwd,trj} as a candidate.

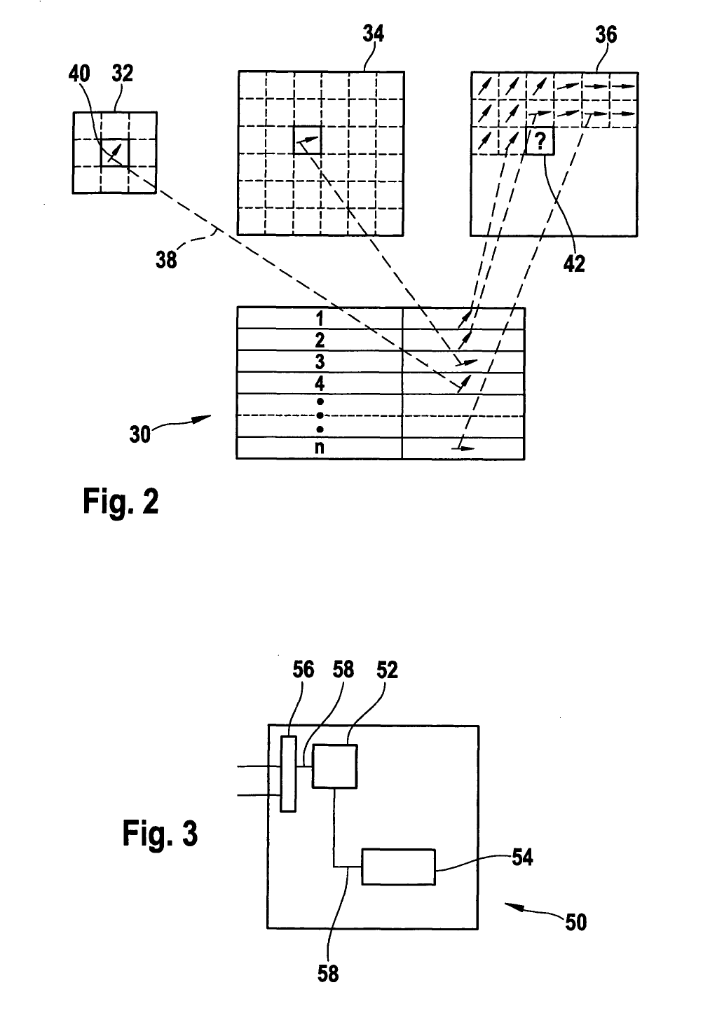

FIG. 2 shows the generation of a motion vector candidate set 30 on the basis of various information sources for a rapid and efficient motion estimation. The various information sources are a current frame 32 having a lower resolution, a previously coded frame 34 which may possibly be taken from a different temporal layer, and a current frame 36 having a higher spatial resolution. A first dashed line 38 illustrates the incorporation of a vector 40, which is scaled at a higher spatial resolution, into list 30. A block 42 provided in current frame 36 indicates current macroblock 42.

FIG. 3 illustrates one specific embodiment of the system according to the present invention, which is collectively designated by reference numeral 50. This system 50 includes a computing unit 52, a memory unit 54, and an input/output unit 56, which are interconnected via data lines 58.

The method for data compression is carried out in computing unit 52, and data, i.e., video sequences, to be compressed are received via input/output unit 56, and after compression may also be relayed by same. Computing unit 52 may also be provided for decompressing compressed data.

1-11. (canceled)

12. A method for compressing data in a video sequence, the method comprising:
obtaining and providing results of a motion estimation for a previous temporal decomposition stage, in which motion parameters of the video sequence are determined, for motion compensation to predict vector candidates for the next decomposition stage; and
providing a predictive algorithm, which includes a candidate set of full-pixel motion vectors, for the motion estimation, wherein individual candidates of a full-pixel candidate set are selected.

13. The method of claim 12, wherein a changing motion in the sequence is adapted to.

14. The method of claim 12, wherein a candidate for the motion vector is determined by minimizing a cost function.

15. The method of claim 12, wherein a data rate-to-image distortion ratio is used to select a coding mode.

16. A system for compressing data in a video sequence, comprising:
a motion estimation arrangement to determine a motion estimation for a previous temporal decomposition stage, in which motion parameters of the video sequence are determined, wherein the motion compensation is used to predict vector candidates for the next decomposition stage; and
a predictive algorithm arrangement, which includes a candidate set of full-pixel motion vectors, for the motion estimation, wherein individual candidates of a full-pixel candidate set are selected.

17. The system of claim 16, wherein the motion estimation arrangement and the predictive algorithm arrangement are encompassed by a computing unit.

18. A computer readable medium having program code, which is executable by a processor, comprising:
a program code arrangement for compressing data in a video sequence by performing the following:
obtaining and providing results of a motion estimation for a previous temporal decomposition stage, in which motion parameters of the video sequence are determined, for motion compensation to predict vector candidates for the next decomposition stage; and
using a predictive algorithm, which includes a candidate set of full-pixel motion vectors, for the motion estimation, wherein individual candidates of a full-pixel candidate set are selected.

19. The computer readable medium of claim 18, wherein the program code arrangement adapts to a changing motion in the sequence.

20. The computer readable medium of claim 18, wherein a candidate for the motion vector is determined by minimizing a cost function.

21. The computer readable medium of claim 18, wherein a data rate-to-image distortion ratio is used to select a coding mode.
